(19) United States
(12) Patent Application Publication
(10) Pub. No.: US 2021/0061554 A1
(43) Pub. Date: Mar. 4, 2021

(54) Trash Receptacle for Table Top

(71) Applicant: Tammy L. Moore, Midlothian, TX (US)

(72) Inventor: Tammy L. Moore, Midlothian, TX (US)

(21) Appl. No.: 16/554,773

(22) Filed: Aug. 29, 2019

(51) Int. Cl. B65F 1/14; F16M 13/02; G08B 21/18

(52) U.S. Cl. CPC B65F 1/141; F16M 13/02; B65F 2210/18; B65F 2210/139; G08B 21/18

(57) ABSTRACT

A trash receptacle for a table top comprising a trash receptacle holding portion and a trash receptacle attachment portion for attaching the trash receptacle to a table top.

### BACKGROUND

### 1. Field of the Invention

The present invention relates in generally to trash receptacles.

### 2. Description of Related Art

Dining out generally involves a lot of disposable or one-time use items, such as plastic utensils, straws, sugar packets, and napkins, and generates a large amount of waste. Often, customers are forced to leave the trash on the table until a server is available to clear the items off the table. This sometimes leads to cluttered tables, which can be especially problematic when table top space is limited. In some restaurants, customers do not have the option to simply gather the trash and easily place it into a nearby trash receptacle. Collection of the trash by the server may also be difficult since customers may place trash items throughout the table rather than in a neat pile.

Although great strides have been made in the area of trash receptacles, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1A and 1B are a perspective view of a trash receptacle for a table top according to the present application;

FIG. 2 is a perspective view of an alternative embodiment of a trash receptacle for a table top according to the present application;

FIG. 3 is a perspective view of an alternative embodiment of a trash receptacle for a table top according to the present application; and

FIG. 4 is a perspective view of an alternative embodiment of a trash receptacle for a table top according to the present application.

While the assembly and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, combinations, and alternatives falling within the spirit and scope of the present application as defined by the appended claims.

### DETAILED DESCRIPTION OF THE PREFERRED EMBODIMENT

Illustrative embodiments of the trash receptacle for table top system are provided below. It will of course be appreciated that in the development of any actual embodiment, numerous implementation-specific decisions will be made to achieve the developer's specific goals; such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

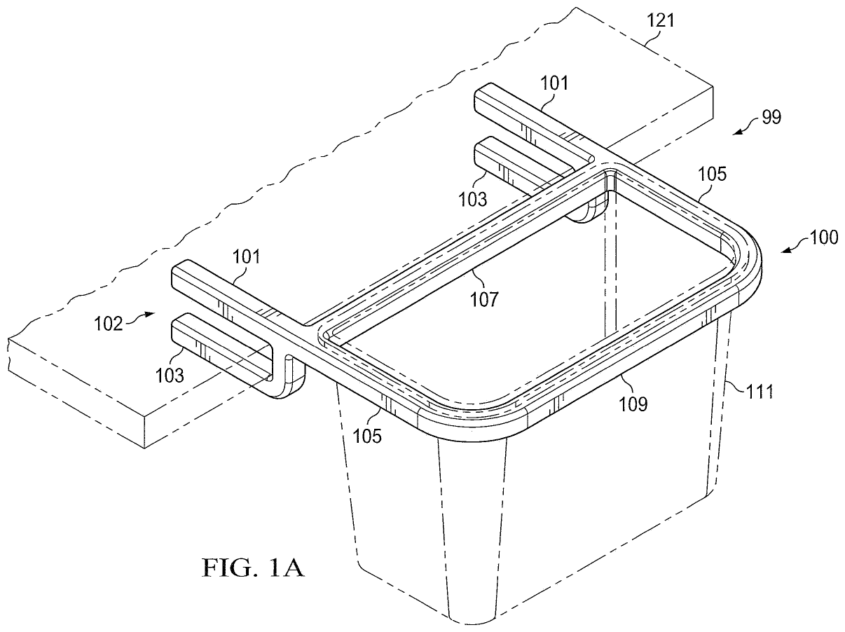

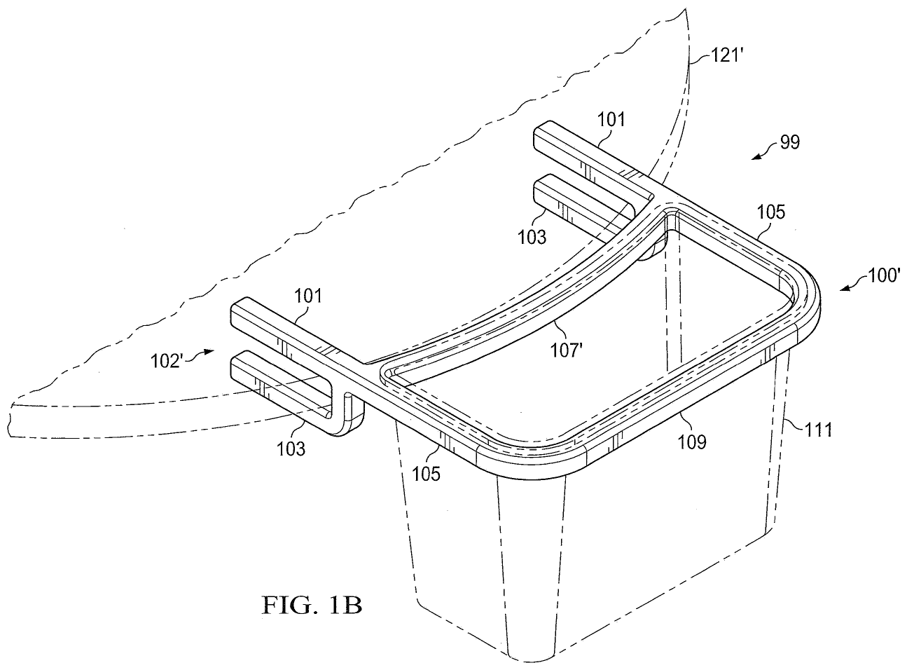

Referring now to FIG. 1A in the drawings, the preferred embodiment of a table-top trash receptacle 99 according to the present application is illustrated. Trash receptacle 99 includes a trash receptacle holding portion 100 and a trash receptacle attachment portion 102. Trash receptacle holding portions 100 is configured for holding a container 111 and trash receptacle attachment portion 102 is configured for attaching trash receptacle 99 to a table top 121. Trash receptacle holding portion 100 generally comprises one or more arms 105, a back bar 107, and a front bar 109. Arms 105 connect to back bar 107, and front bar 109 and provides structural support for holding container 111. It will be appreciated that trash receptacle 99 may be divided into multiple compartment for holding multiple containers 111.

As depicted, container 111 is rigid and has a lip that is supported by arms 105, back bar 107 and front bar 109. In some embodiments, the lips of container 111 are specially contoured to fit precisely into the trash receptacle holding portion 100. It will be appreciated that trash receptacle holding portion 100 may be a different shape than as shown, such as circular, and container 111 will be similarly shaped to fit into trash receptacle holding portion 100. Additionally, container 111 can easily be removed, so that container 111 can be cleaned or quickly replaced with another container 111. Container 111 may be reusable or disposable. While container 111 is shown as rigid, it should be understood that container 111 can be made from any type of material, including flexible materials such as silicon. In an alternative embodiment, container 111 may be replaced with a plastic bag. Front bar 109 may be removed, so that arms 105 can be used to hold the handles of the plastic bag and secure the plastic bag to trash receptacle holding portion 100.

Trash receptacle attachment portion 102 generally comprises top legs 101 and bottom legs 103. As depicted, top legs 101 and bottom legs 103 combine to form a pair of U-shaped prongs in trash receptacle attachment portion 102 that uses gravity to passively attach trash receptacle holding portion 100 to table top 121. Trash receptacle holding portion 100 is removed from table top 121 by sliding trash receptacle attachment portion 102 away from table top 121. Similarly, trash receptacle holding portion 100 is attached to table top 121 by sliding trash receptacle attachment portion 102 toward table top 121 so that top legs 101 are on the table top 121 and bottom legs 103 are below table top 121.

The portions of trash receptacle attachment portion 102 that are in direct contact with table top 121 may include materials that increase the non-slip and/or gripping ability of trash receptacle attachment portion 102, such as rubber, silicon or foam. In some embodiments, trash receptacle attachment portion 102 may be coated, embossed, gnarled or treated with the non-slip surface finish. In other embodiments, trash receptacle attachment portion 102 may be adjustable to accommodate table tops of different sizes. For example, trash receptacle attachment portion 102 may include an affirmative clamping device, such as a thumb screw or spring loaded clamp, where the distance between top legs 101 and bottom legs 103 can be adjusted to fit table top 121 properly.

Trash receptacle holding portion 100 and trash receptacle attachment portion 102 are attached. Specifically, arms 105 of trash receptacle holding portion 100 are directly connected to top legs 101. Back bar 107 is in direct contact with table top 121 and connects right top legs 101 and right bottom legs 103 to left top legs 101 and left bottom legs 103.

Referring now to FIG. 1B in the drawings, trash receptacle 99′, which includes a trash receptacle holding portion 100′ and a trash receptacle attachment portion 102′ has almost the same form and function as trash receptacle 99 in FIG. 1A. As shown in FIG. 1B, trash receptacle holding portion 100′ can be attached to table tops that do not have a straight edge. Indeed, trash receptacle frame 100′ is attached to table top 121′, which is circular. To accommodate circular table top 121′, back bar 107′ is arched to fit the contour of table top 121′.

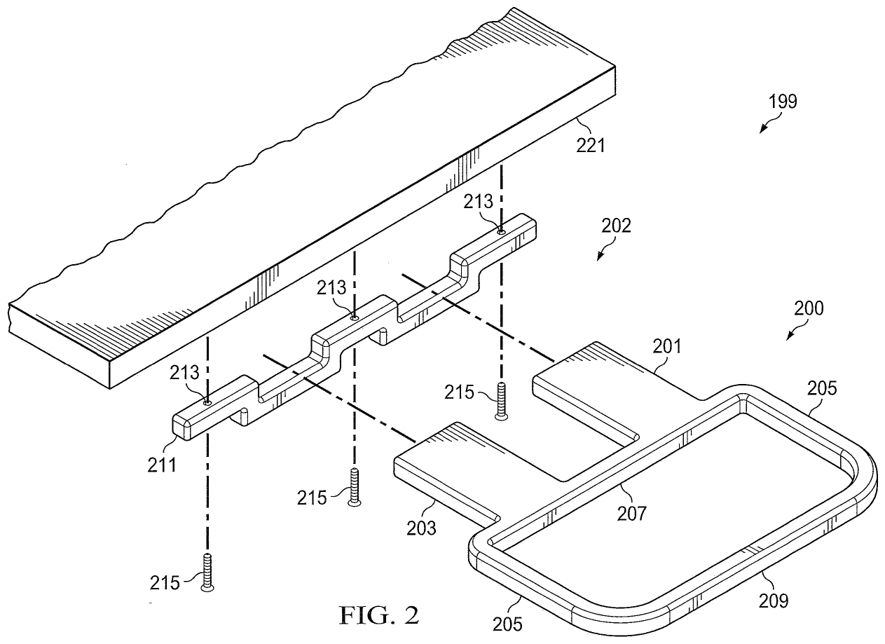

Referring now to FIG. 2 in the drawings, an alternative embodiment a table-top trash receptacle 199 according to the present application is illustrated. Trash receptacle 199 includes a trash receptacle holding portion 200 and a table attachment system 202. Trash receptacle holding portions 200 is configured for holding a trash receptacle and trash receptacle attachment portion 102 is configured for attaching trash receptacle 199 to a table top 221. Trash receptacle holding portion 100 generally comprises one or more arms 205, a back bar 207, and a front bar 209. Arms 205 connect to back bar 207, and front bar 209 and provides structural support for holding the trash receptacle. Any type of trash receptacle, such a plastic container, plastic bag, silicon container, etc., may be secured to trash receptacle holding portion 200 to collect trash.

Table attachment system 202 is used to attach trash receptacle holding portion 200 to table top 221 and generally comprises an elongated right tab 201, an elongated left tab 203, a mounting bar 211, one or more screw holes 213 and one or more screws 215. Mounting bar 211 has screw holes 213 for receiving screws 215. Screws 215 secure mounting bar 211 to directly to the bottom of table top 221. Mounting bar 211 also has recesses for receiving right tab 201 and left tab 203. Once right tab 201 and left tab 203 are inserted into the space between the recesses in mounting bar 211 and table top 221, trash receptacle holding portion 200 is ready for use. In the preferred embodiment, right tab 201 and left tab 203 would extend several inches past mounting bar 211 under table top 221 in order to best secure trash receptacle holding portion 200 to table top 221.

Trash receptacle holding portion 200 can be removed by sliding right tab 201 and left tab 203 out of the space between the recesses in mounting bar 211 and table top 221 and away from table top 221. It should be understood that trash receptacle holding portion 200 can have any number of prongs and mounting bar 211 could easily be designed to receive the correct number of prongs. For example, trash receptacle holding portion 200 may be small in size and only require one prong to securely attach to table top 221. In that case, mounting bar 211 would only have one recess and two screw holes 211 and require two screws 215 for attachment. In another embodiment, trash receptacle holding portion 200 may be much larger in size, such as the width of table top 221, and four prongs are needed to securely attach to table top 221. In that case, mounting bar 211 would only have four recesses and five screw holes 211 and require five screws 215 for attachment.

Right tab 201 and left tab 203 are connected to back bar 207. Arms 205 connect to back bar 207 and front bar 209 and provides structural support for holding a trash receptacle. The trash receptacle can be placed within the void area of trash receptacle frame 200 so that it can easily be removed to be cleaned or quickly replaced with another container. In some embodiments, the trash receptacle may be a plastic bag. Front bar 209 may be removed so that arms 205 can be used to hold the handles of the plastic bag and secure the plastic bag to trash receptacle frame 200.

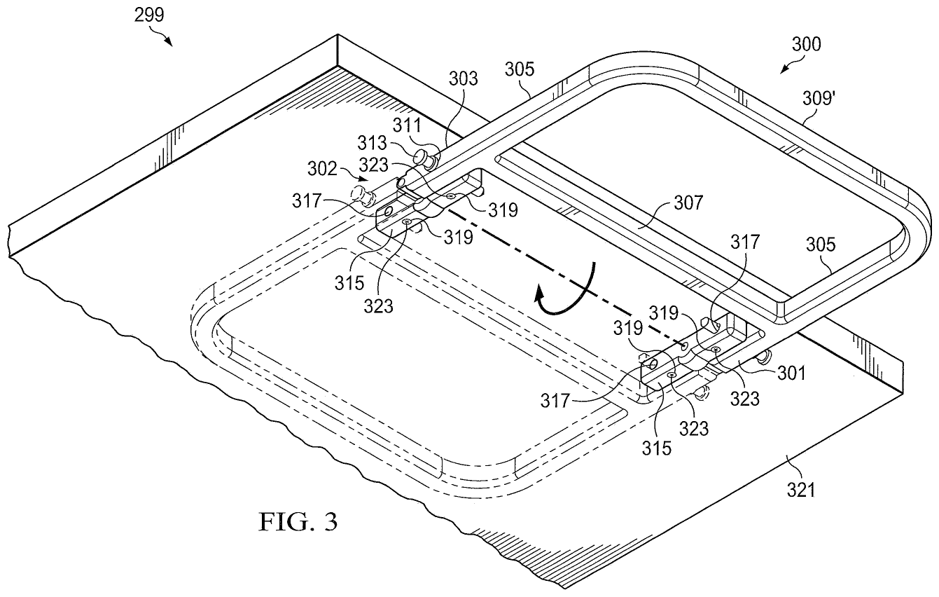

Referring now also to FIG. 3 in the drawings, an alternative embodiment a table-top trash receptacle 299 according to the present application is illustrated. Trash receptacle 299 includes a trash receptacle holding portion 300 and a table attachment system 302. Trash receptacle holding portions 300 is configured for holding a trash receptacle and table attachment system 302 is configured for attaching trash receptacle 299 to a table top 321. Trash receptacle holding portion 300 generally comprises a right prong 301, a left prong 303, one or more arms 305, a back bar 307, a front bar 309, and a locking pin hole 311. Arms 305 connect to back bar 307, and front bar 309 and provides structural support for holding the trash receptacle. Any type of trash receptacle, such a plastic container, plastic bag, silicon container, etc., may be secured to trash receptacle holding portion 300 to collect trash.

Table attachment system 302 is used to attach trash receptacle holding portion 300 to table top 321. Table attachment system 302 comprises one or more locking pins 313 and one or more mounting brackets 315. Each mounting bracket 315 includes one or more locking pin holes 317 and one or more screw holes 319. Mounting brackets 315 are secured to the bottom of table top 321 with one or more screws 323.

Trash receptacle holding portion 300 is attached to table attachment system 302 with locking pins 313. Each locking pin 313 is inserted into locking pin hole 311 in trash receptacle holding portion 300 and then through locking pin hole 317 in table attachment system 302. There is one locking pin 313 used on right prong 301, which is inserted into front locking pin holes 311 and 317, and one locking pin 313 used on left prong 303, also inserted into front locking pin holes 311 and 317, to secure the trash receptacle holding portion 300 to table top 321. When trash receptacle holding portion 300 is no longer needed, it can be stored under table top 321. In order to store trash receptacle holding portion 300 under table top 321, locking pins 313 are removed from front locking pin holes 311 and 317, trash receptacle holding portion 300 is pivoted to fit under table top 321, and locking pins 313 are placed into rear locking pin holes 311 and 317. It should be understood that table attachment system 302 may any type of pivoting and locking mechanism to secure trash receptacle frame 300 to table attachment system 302, such as a spring biased system or a spring loaded system.

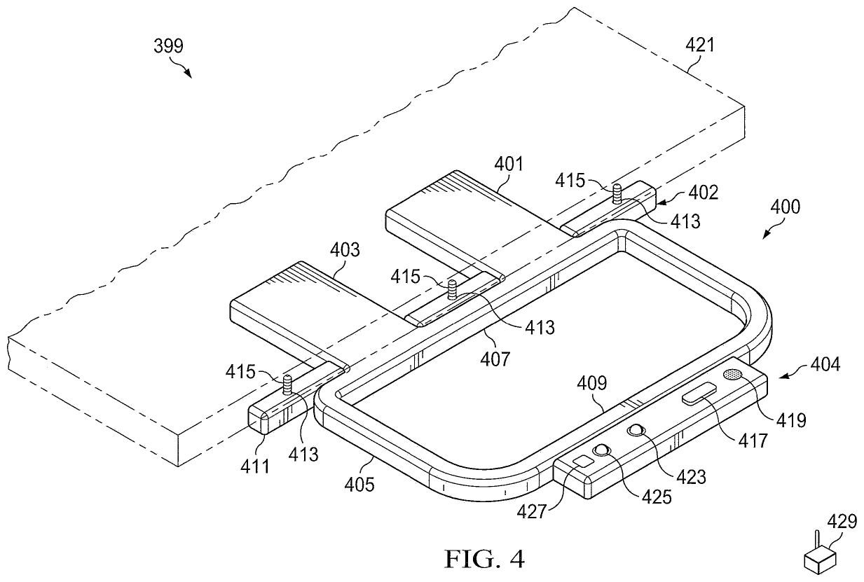

Referring now to FIG. 4 in the drawings, an alternative embodiment a table-top trash receptacle 399 according to the present application is illustrated. Trash receptacle 399 includes a trash receptacle holding portion 400, a table attachment system 402 and an alert system 404. Trash receptacle holding portion 400 and table attachment system 402 are similar to trash receptacle holding portion 200 and table attachment system 202, respectively, in form and function.

Alert system 404 can be used to alert a server when the trash receptacle needs to be emptied. Alert system 404 generally comprises a button 417, a speaker 419, one or more lights 423 and 425, and one or more wireless receivers and transmitters 427 and 429. A customer could push button 417 and a beep through speaker 419 can alert the customer and/or the server that a request to empty the receptacle has been made. Since there may be a unit at each table, lights 423 and 425 can be used to help indicate which table made the request. For example, light 423 can be green, to indicate that the table does not need service, and light 425 can be red, to indicate that a request has been made at that particular table. Light 423 is turned on by default until button 417 is pressed, then light 423 turns off and light 425 turns on. When a server services the table, the server can reset the lights by turning light 425 off and turning light 423 on. It can be appreciated that a single light may replace the functionality provided by lights 423 and 425, or additional lights can be added to increase the number of alerts available. In an alternative embodiment, a customer could push button 417 and the request would be transmitted from wireless transmitter 427 and the request would be received at wireless receiver 429, which would alert a server or other restaurant employee of the request. In some embodiments, wireless receiver 429 may be integrated with the restaurant's POS system. It should be understood that this type of alert system is merely exemplary, and additional features can be added, such as a touchscreen display, additional lights, means for the customer and server to communicate over the speaker, means to notify the server of other requests, means to send requests wirelessly, etc.

It is apparent that a system and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

I claim:

1. A trash receptacle for a table top, comprising:
a trash receptacle holding portion comprising:
at least one arm; and
a back bar; and
a trash receptacle attachment portion comprising:
at least one top leg; and
at least one bottom leg;
wherein the trash receptacle holding portion and the trash receptacle attachment portion are integral with each other.

2. The trash receptacle according to claim 1, wherein the trash receptacle holding portion further comprises:
a front bar.

3. The trash receptacle according to claim 2, wherein the at least one top leg and at least one leg form a U-shaped clevis.

4. The trash receptacle according to claim 2, wherein the at least one bottom leg further comprises:
a clamp that is configured to adjustably attach the trash receptacle to the table top.

5. The trash receptacle according to claim 1, wherein the back bar is contoured to fit the shape of the table top.

6. The trash receptacle according to claim 2, wherein the trash receptacle attachment is coated with a non-slip surface finish.

7. A trash receptacle for a table top, comprising:
a trash receptacle holding portion comprising:
at least one arm; and
a back bar; and
a table attachment system comprising:
a mounting system that is configured for attaching the trash receptacle to the table top.

8. The trash receptacle according to claim 7, table attachment system further comprises:
at least one elongated tab coupled to the trash receptacle holding portion; and
wherein the mounting system comprises:
a mounting bar; and
wherein the elongated tab can be inserted into the mounting bar.

9. The trash receptacle according to claim 8, wherein the trash receptacle holding portion is completely detachable from the mounting bar.

10. The trash receptacle according to claim 7, table attachment system further comprises:
a mounting bracket; and
at least one locking pin;
wherein the at least one locking pin can be inserted into the mounting bracket and the trash receptacle holding portion.

11. The trash receptacle according to claim 10, wherein the trash receptacle holding portion is pivotally connected to a table.

12. The trash receptacle according to claim 7, wherein the trash receptacle holding portion can be stored under a table top.

13. The trash receptacle according to claim 1, further comprising:
an alert system.

14. The trash receptacle according to claim 13, wherein the alert system comprises:
at least one wireless receiver and transmitter.

15. The trash receptacle according to claim 13, wherein the alert system comprises:
a speaker.

16. The trash receptacle according to claim 13, wherein the alert system comprises:
at least one light.

17. A method for attaching a trash receptacle to a table top, comprising:
providing a trash receptacle comprising:
a trash receptacle holding portion; and
a trash receptacle attachment portion;
attaching the trash receptacle to a table top;
placing a container for collecting trash into the trash receptacle holding portion.

18. The method for attaching a trash receptacle to a table top according to claim 17, wherein the trash receptacle further comprises an alert system.

19. The method for attaching a trash receptacle to a table top according to claim 18, further comprising:
responding to an alert from the alert system.

20. The method for attaching a trash receptacle to a table top according to claim 17, further comprising:
removing trash from the container.
